(19) United States
(12) Patent Application Publication
(10) Pub. No.: US 2015/0012389 A1
(43) Pub. Date: Jan. 8, 2015

(54) APPARATUS, METHOD AND SOFTWARE PRODUCTS FOR TIMELY PROVISION OF A PRODUCT OR SERVICE

(71) Applicant: Alexander PERMAN, Tel Aviv (IL)

(72) Inventor: Alexander PERMAN, Tel Aviv (IL)

(21) Appl. No.: 14/314,054

(22) Filed: Jun. 25, 2014

Related U.S. Application Data
(60) Provisional application No. 61/842,399, filed on Jul. 3, 2013.

(51) Int. Cl. G06Q 30/06

(52) U.S. Cl. CPC G06Q 30/0635
USPC 705/26.81

(57) ABSTRACT

The present invention provides systems and methods for time-dependent payment for a service or product, the method including defining a planned time for provision of a service or product to a user location from a service or product provider, measuring an actual time for the provision to the user location of the service or product and reducing the payment for the service or product responsive to a quantification of delay between the actual time and the planned time.

### FIELD OF THE INVENTION

The present invention relates generally to apparatus and methods for provision of goods or services, and more specifically to time-dependent payment for timely provision of the goods and services.

### BACKGROUND OF THE INVENTION

Many services and products can be ordered via the Internet, from a cellphone or fixed phone. However, some services promise timely supply or provision of the goods/services and fail to deliver in the promised timeframe. This is most annoying, particularly when one is ordering fast food or supermarket services. Often, one loses a day's work or part of a day's work, when a service provider, such as a washing machine mechanic, electrician plumber, air-conditioning engineer or other tradesperson promises to arrive within a four hour timeframe. Sometimes, the tradesperson arrives after five or six hours of waiting. This kind of service is wasteful, time-consuming and most annoying. Yet more annoying is when the service provider arrives outside the pre-defined time frame and is most cheerful and not in the least apologetic.

### SUMMARY OF THE INVENTION

It is an object of some aspects of the present invention to provide apparatus and methods for time-dependent payment for timely provision of goods and services.

It is another object of some aspects of the present invention to provide software products for time-dependent payment of goods or services.

It is another object of some further aspects of the present invention to provide apparatus and methods for enhanced time-dependent payment for goods and/or services.

There is an urgent need to provide consumers with a system and method which preserves the value of their time and penalizes the provider for wasting such time.

The present invention provides a method for time-dependent payment for a service or product, the method comprising:
a. defining a planned time for provision of a service or product to a user location from a service or product provider;
b. measuring an actual time for the provision to the user location of the service or product; and
c. reducing the payment for said service or product responsive to a quantification of delay between the actual time and the planned time.

The present invention further provides computer software product, said product configured for providing time-dependent payment for a service or product, the product comprising a computer-readable medium in which program instructions are stored, which instructions, when read by a computer, cause the computer to:
a. define a planned time for provision of a service or product to a user location from a service or product provider;
b. measure an actual time for the provision to the user location of the service or product; and
c. reduce the payment for the service or product responsive to a quantification of delay between the actual time and the planned time.

The present invention further provides a system for providing time-dependent payment for a service or product, the system comprising:
a. a processing element adapted to:
   i. define a planned time for provision of a service or product to a user location from a service or product provider;
   ii. measure an actual time for the provision to the user location of the service or product; and
   iii. reduce the payment for the service or product responsive to a quantification of delay between the actual time and the planned time.
b. a multimedia communication device associated with the user, said device comprising:
   i. a processing device adapted to:
      a) activate an algorithm to upload screenshots to order a service or product;
      b) display an actual time for the provision to the user location of the service or product; and
      c) display a reduction in the payment for the service or product responsive to a quantification of delay between the actual time and the planned time; and
c. at least one communications network for enabling communication between the multimedia communication device and the processing element.

The present invention will be more fully understood from the following detailed description of the preferred embodiments thereof, taken together with the drawings.

### BRIEF DESCRIPTION OF THE DRAWINGS

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail then is necessary for a fundamental understanding of the invention, the description taken with the drawings making apparent to those skilled in the art how the several forms of the invention may be embodied in practice.

In the drawings:

FIG. 1 is simplified pictorial illustration of a system for timely provision of a service or product, in accordance with an embodiment of the present invention;

FIG. 2 illustrates a flowchart diagram of a method for timely provision of a service or product, in accordance with an embodiment of the present invention; and

FIGS. 3A , 3B and 3C illustrate a flowchart diagram of a scenario for utilizing the system in a restaurant, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

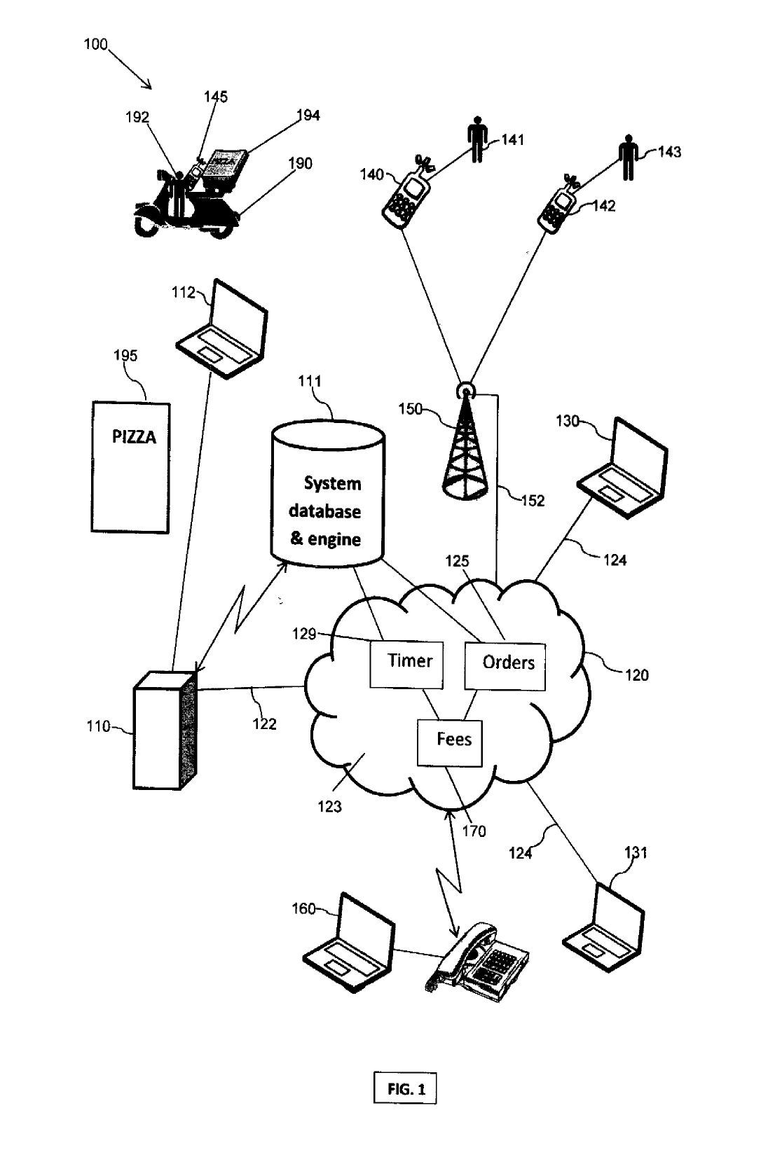

Reference is now made to FIG. 1, which is a simplified pictorial illustration showing a system 100 for time-dependent payment for a service or product, in accordance with an embodiment of the present invention.

System 100 typically includes a server utility 110, which may include one or a plurality of servers and one or more control computer terminals 112 for programming, trouble-shooting servicing and other functions. Server utility 110, includes a system engine and database, 111, an orders ranking module 125; a minimizing total duration module, 129, and a fees module 170, which are linked to the Internet 120 (constituting a computer network) through link 122, for running matching application 123 for time-dependent payment for a service or product in system 100.

Together, user-generated meetings are generated. Both users 141, 143 may communicate with server 110 through a plurality of user computers 130, 131, or user mobile devices 140, 142, which may be mainframe computers with terminals that permit individual to access a network, personal computers, portable computers, small hand-held computers smart phones and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein. Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used. The system 100 also typically includes at least one call and/or user support center 160. The service center typically provides both on-line and off-line services to users. The server system 110 is configured according to the invention to carry out the above-described method for automatic or non-automatic appointment matching. Meeting matching is performed by modules 123, 125, 127, through an API (Application Programming Interface), 171. Some of the screen shots of the website appear herein below.

A service provider 195, such as a fast food store sends a service or product 194 with a service messenger/professional 192 in/on a vehicle 190. The service messenger/professional also has a mobile device 145 such as a smartphone which defines his/her location over time.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet.

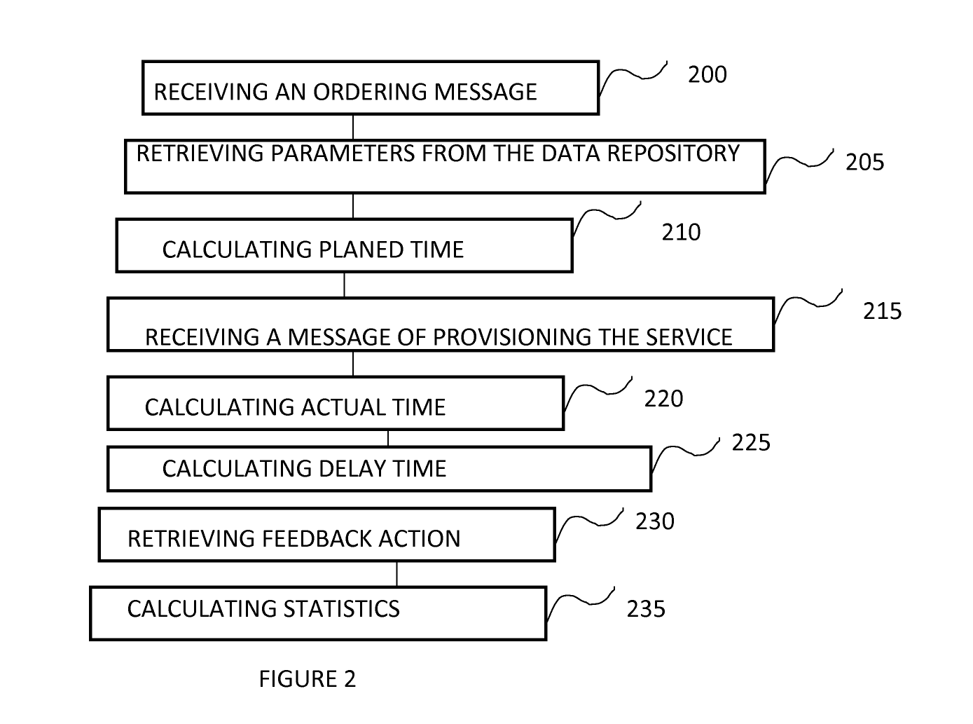

Reference is now made to FIGS. 2A-2E, which are simplified pictorial illustrations of sequential multimedia portable communication device screen shots 200, 205, 210, 215 and 250 in the method for time-dependent payment, in accordance with an embodiment of the present invention.

In the first screen shot 200, a user connects to a website of a product provider, such as store 195 (FIG. 1). He orders a product, such as pizza 194 (FIG. 1). On the screen there is a countdown button 206 and delivery button 204 and an order button 202. When he presses the order button, timer 129 is activated. The time provided for the provision of the service/products is defined by the system according to the time for preparation of the product and delivery time from the store to the user location. In this case, it was set for 30 min, as can be seen in FIG. 2B—a time duration 208 in min is 30.

As can be seen in FIG. 2C, there are onscreen buttons to track the order placed 212, preparation time 214, bake time 216 and quality check time 218.

FIG. 2D shows an onscreen map 220 mapping a route 221 designated for messenger 192. The countdown time 222 is now 10 min.

In FIG. 2E, it is seen that there has been a delay 224 of 3 minutes. An onscreen fine button 228 uploads the time dependent fine or alternatively, reduction in cost of the pizza.

The same method can be applied to the provision of services. For example, if a washing machine mechanic commits to arriving within two hours and arrives after 4 hours, he may be fined or the total cost for his services may be reduced per five minutes of delay.

Additionally or alternatively, the user/consumer may be provided with some other sort of compensation (reduction in cost of the next pizza, free washing machine part or free next delivery, for example). The user may be provided with interactive screens to input customer satisfaction indices or other feedbacks concerning the service, product and/or supply time.

Exemplary implementation of the present inventive concept is better described with reference to the accompanying drawings. It should be understood that the mobile devices may be old or new smartphones, androids, tablets or any other communication devices known in the art.

The system of the present invention is also constructed and configured to track all messengers in a fleet of messengers and to note their timely/non-timely delivery and return to the store/branch from which they travelled.

The system of the present invention is further constructed and configured to determine the time for delivery of an item, based on the distance from the provision point (store, for example) to the user/consumer, as well as local traffic conditions, and to track all messengers in a fleet of messengers and to note their timely/non-timely delivery and return to the store/branch from which they travelled.

FIG. 2 illustrates a flowchart diagram of a method for timely provision of a service or product, in accordance with an embodiment of the present invention. Such a method enables to monitor the actual time and to provide feedback action if the actual time is greater than planned time. The actual time is the time that elapses between the ordering of the product or the service and the provisioning of the product or the service. The feedback action may be a reward that is provided to the user. Such a reward may include a coupon, a discount and a free product or service. In some embodiment the feedback action may include updating statistics related to quality of service of the product or service for improving the quality of the service. The method illustrated in FIG. 2 may be implemented by a server.

At 200 a message including an event of ordering a product or a service is received. The message may include an identification of the product or the service and an identification of the location of the user. The message may be received from a computerized device of a user who orders the product or the service. For example, the message may be received from a Smartphone of a user who ordered a pizza. In such a case the location of the user is retrieved by the GPS of the Smartphone and may include the location of the Smartphone and a number that identifies the Pizza that was ordered and a number that identifies the order.

At 205 the server retrieves from a data repository parameters associated with the product or service or with the location of the user. In one example the server retrieves from the data repository parameters associated with the expected time for backing the pizza, the current availability of the bakers and the ovens and the like. The parameters associated with the location may include expected time for arriving to the location. Such expected time may be retrieved from applications such as Waze.

At 210 a planned time for provision of the service or product to a user location is calculated. The calculating may be associated with the parameters retrieved in block 305 and with the location of the user. For example, in the case of ordering a Pizza the time of preparing the pizza is calculated based on the availability of the resources, the estimated time for preparing and baking the Pizza and the expected delivery time.

At 215, an event of provisioning to the user location of the service or product is received. The event may be received from a remote computerized device. For example, the application of the Smartphone may identify the arrival of a person that delivers the pizza to the location and may send a message of the event to the server.

At 220 the actual time of provisioning the service is calculated. In some embodiment the time of ordering a product or service is extracted from the message of the event of ordering a product or service and the time of provisioning the product or service is extracted from the message of the event of provisioning the product or service. The actual time may be calculated by subtracting the time of ordering the service or product from the time of provisioning the service or product.

At 225 a delay between the actual time and the planned time is calculated.

At 230 a feedback action that is associated with the delay is retrieved from the database. The feedback action may be proportionally to the delay. For example, the feedback action may be a discount of the price of the pizza proportionally to the time of the delay; that is to say a longer delay entails a greater decrease in the price of the pizza.

At 235 statistics are calculated according to the delay. The statistics may be related to the quality of service. Example of such statistics may be statistics of delay per a delivery person, per time and date per a location of the user and the like.

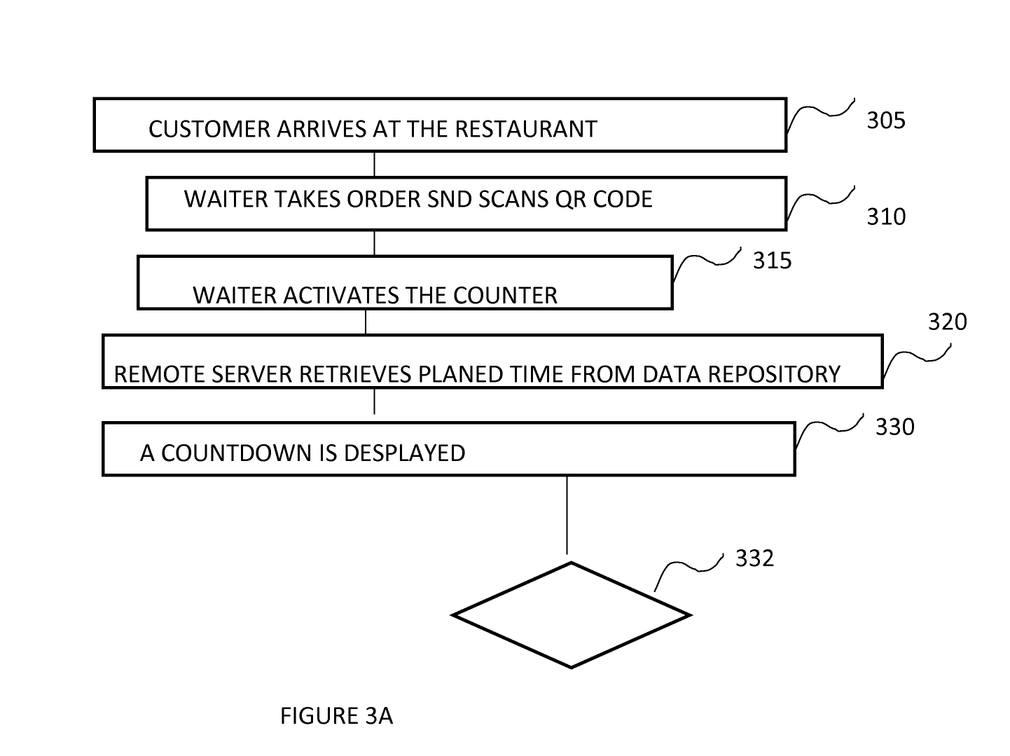

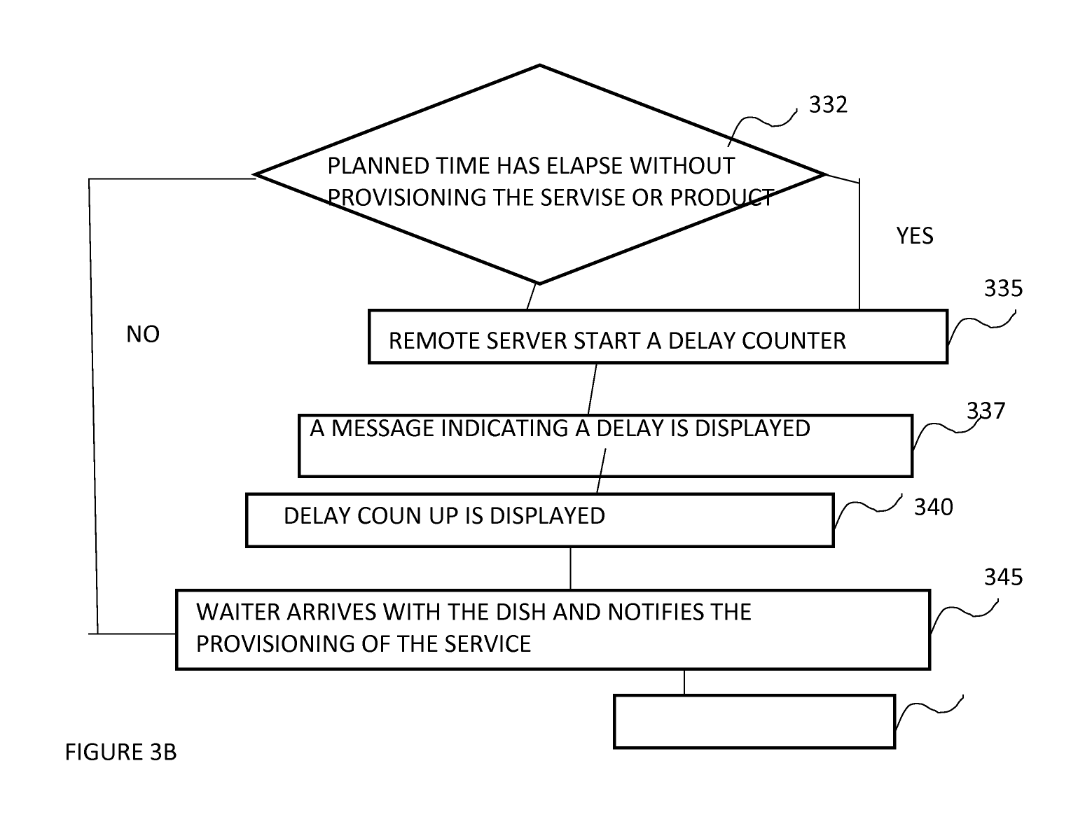

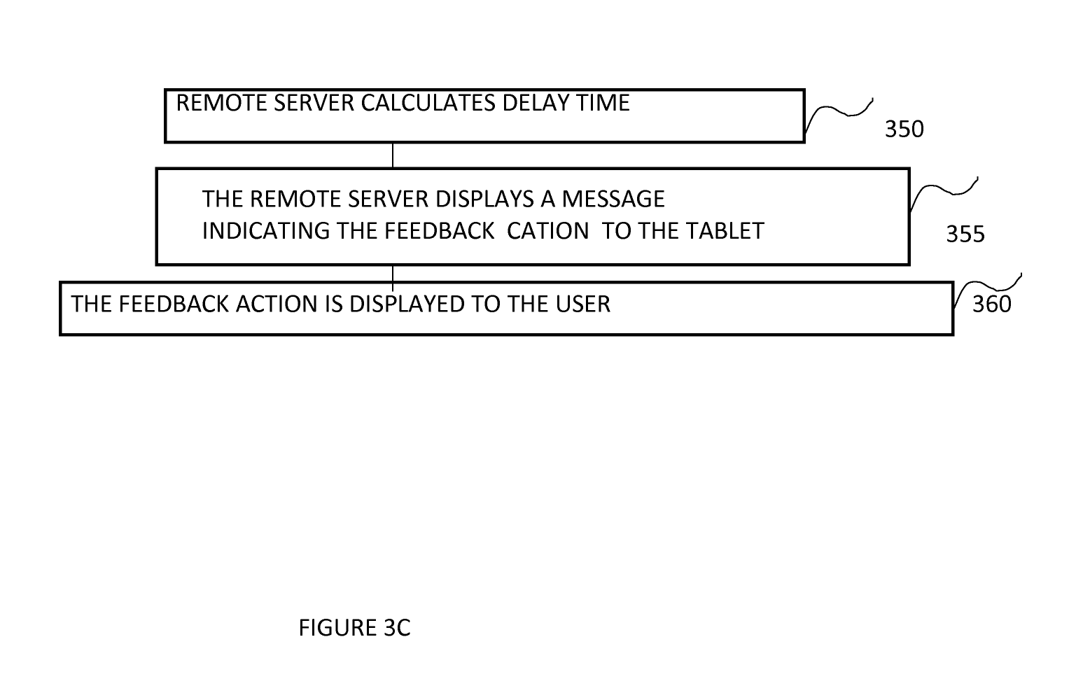

FIGS. 3A and 3B and 3C illustrate a flowchart diagram of a scenario for utilizing the system in a restaurant, in accordance with an embodiment of the present invention.

At 305, the customer arrives at a restaurant and scans a QR code with his cellular telephone. According to some embodiments the QR code is specific to the table in which the customer is sited. As a result the web site of the application for timely provisioning a product or a service that is opened at the customer cellular phone. More specifically a page of this web site that is associated with the table in which the customer is sited is opened on the Smartphone of the customer.

At 310, the waiter takes an order from the customer.

At 315 the waiter activates a counter of the table in which the customer is sited. Activating may be done by, for example, touching an icon representing the table on a tablet. As a result an event message including the identifier of the table, and the order time is transferred from the tablet to the remote server.

At 320, the remote server retrieves from the database the planed time that is associated with the time and date of the event message. The planed time may differ according to the time and date, for example the planed time associated with the morning may be shorter than the planed time associated with the night and the planed time associated with a holiday may be substantially shorter then a planed time of a weekday.

At 330 a countdown is displayed to the user on his Smartphone. The countdown indicates the time that is left till the end of the planed time.

At 332 a check is performed by the server to identify if the planed time has elapse without provisioning the service.

Blocks 335, 337 and 340 are performed if the planed time has elapse without provisioning the service,

At 335 the remote server starts a new counter that indicates the delayed time.

At 337 a message indicating an event of starting a delayed time is displayed on the Smartphone of the user.

At 340, the a count up of the delayed time is displayed on the Smartphone of the user.

At 345 the waiter arrives with the dishes. The waiter notifies the application, by, for example touching an icon related to the table in a tablet, that the dish has arrived. As a result a message indicating the provisioning of the order is sent from the tablet to the remote server.

At 350, which occurs if a delayed time exists, the remote server calculates the delayed time and retrieves from the data base a feedback action associated with the delay time.

At 355, the remote server displays a message indicating the provisioning of the service to the user. If a feedback action exists the server sends the identification of the feedback action to the tablet.

At 360 the tablet displays a message indicating the provisioning of the service and if a feedback action exists the tablet displays a notification of the feedback action. Examples of feedback actions are is a discount in the price of the meal, cash-back or or the notification may be also sent to the point of sale of the restaurant for updating the price.

It should be noted that other configurations may be used for implementing the scenario. For example, a tablet may be displayed on each table and the user may view the messages from the server on the tablet. It sould also be noted that the suer may doenload the application instead of or in addition to scanning the QR code.

It should also be noted that another exemplary “take away” scenario may also be implemented by method for timely provision of a service or product. In such a case the customer does not have to actually sit in the restaurant.

Some embodiments of the invention are herein described, by way of example only. For purpose of explanation examples are set forth based in image processing in order to provide better description of the invention. However, it will also be apparent to one skilled in the art that the invention is not limited to the examples described herein and applied to sound and motion.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for timely provision of a service or product, the method comprising:
a. receiving from a remote computerized device a first message indicating an event of ordering a product or a service; said first message comprises an identification of said product or said service and an identification of said location of said user;
b. retrieving from a data repository parameters associated with said product or said service or with said location of said user;
c. calculating a planned time for provision of said service or product to a user location; said calculating being associated with at least one of said parameters and said location of said user; and
d. receiving a second message indicating an event of provisioning to said user location of the service or product;
e. calcuating according to said first message and said second message a delay between an actual time of provisioning said product or said service and said planed time; and
f. retrieving from a data repository a feedback action associated with said delay wherein said feedback action being proportionally to said delay.

2. A method according to claim 1, wherein said calculating of said planned time being based on at least one of a distance from a provider to said user location and data related to local traffic conditions between said provider and said user location.

3. A method according to claim 1, wherein said product is selected from a fast food product, a store order and a consumer product.

4. A method according to claim 3, wherein said fast food product is selected from a pizza, ice cream, hamburgers, a beverage, a food product, a meal and combinations thereof.

5. A method according to claim 1, wherein said service is a home provision service, a professional service, a transport provision service and combinations thereof.

6. A method according to claim 5, wherein said home provision service is selected from the group consisting of a home improvement service, a home machine technical service, a home cleaning service and a home decorating service.

7. A method according to claim 5, wherein said professional service is selected from a medical professional service, a dental service, a cosmetic service, a psychology professional service, an alternative health service, a legal service and an accounting service.

8. A method according to claim 5, wherein said transport provision service is selected from the group consisting of a taxi service, a car rental service, a bus service, a train service, a water transport service and a flight service.

9. A method according to claim 1, further comprising transmitting a first time of said first event to a remote computerized device of said user; thereby enabling the displaying of a first countdown of said actual time and a second countdown of said delay time on said remote computerized device.

10. A method according to claim 1, wherein said payment is reduced proportionally to the delay.

11. A method according to claim 1, further comprising calculating statistics according to said delay.

12. A computer software product, said product configured for providing time-dependent payment for a service or product, the product comprising a computer-readable medium in which program instructions are stored, which instructions, when read by a computer, cause the computer to:
a. receiving from a remote computerized device a first message indicating an event of ordering a product or a service; said first message comprises an identification of said product or said service and an identification of said location of said user;
b. retrieving from a data repository parameters associated with said product or said service or with said location of said user;
c. calculating a planned time for provision of said service or product to a user location; said calculating being associated with at least one of said parameters and said location of said user; and
d. receiving a second message indicating an event of provisioning to said user location of the service or product;
e. calcuating according to said first message and said second message a delay between an actual time of provisioning said product or said service and said planed time; and
f. retrieving from a data repository a feedback action associated with said delay wherein said feedback action being proportionally to said delay.

13. A system for providing time-dependent payment for a service or product, the system comprising:
a. a server adapted to:
i. receiving a first event of ordering a product or a service; said first event comprises an identification of said product or said service and an identification of said location of said user;
ii. retrieving from a data repository parameters associated with said product or said service or with said location of said user;
iii. calculating a planned time for provision of said service or product to a user location; said calculating being associated with at least one of said parameters and said location of said user;
iv. receiving from a remote computerized device a second event of provisioning to said user location of the service or product;
v. calculating actual time of provisioning said service according to a first time associated with said first event and a second time associated with said second event;
vi. calculating a delay between the actual time and the planned time; and
vii. retrieving from a data repository a feedback action associated with said delay wherein said feedback action being proportionally to said delay.
b. a computerized device associated with said user, said device comprising:
a communication unit adapted to:
receiving said first time of said first event and said second time of said second event from said server;
a display unit adapted to:
displaying a first countdown of said actual time and a second countdupn of said delay time on said remote computerized device; and
at least one communications network for enabling communication between said computerized device and said server.

13. The system claim 13 wherein the communication unit is farther configured for receiving said feedback action associated with said delay and wherein said displaying unit is farther configured for displaying said feedback action;

14. The system of claim 13 wherein said feedback action further comprising one member of a group consisting of providing a coupon, reducing price of said service and providing other services or other products to said user.
